(19) United States
(12) Patent Application Publication
(10) Pub. No.: US 2016/0033961 A1
(43) Pub. Date: Feb. 4, 2016

(54) Production Control Support Apparatus and Production Control Support Method

(71) Applicant: Kabushiki Kaisha Toshiba, Tokyo (JP)

(72) Inventors: Shigeta KUNINOBU, Yokohama (JP); Takufumi YOSHIDA, Funabashi (JP)

(73) Assignee: Kabushiki Kaisha Toshiba

(21) Appl. No.: 14/810,544

(22) Filed: Jul. 28, 2015

(30) Foreign Application Priority Data
Jul. 30, 2014 (JP) 2014-155240

(51) Int. Cl. G05B 19/418; G06N 7/00

(52) U.S. Cl. CPC G05B 19/41875; G06N 7/005; G05B 2219/32177; G05B 2219/32368

(57) ABSTRACT

A production control support apparatus according to one embodiment includes processing circuitry. The processing circuitry calculates a plurality of different functions depending on respective regions of the upper bound value based on: a number of machines existing in each process; a time interval of the semi-finished products arriving at the production line; a statistical dispersion of the time interval; a time necessary for one machine in each process to process one semi-finished product; and a statistical dispersion of the necessary time; and thereby obtains a relationship between the upper bound value and the blocking probability for each of the regions, and an association of the functions of the respective regions is a function where the blocking probability monotonically decreases depending on an increase of the upper bound value.

### CROSS-REFERENCE TO RELATED APPLICATIONS

This application is based upon and claims the benefit of priority from Japanese Patent Application No. 2014-155240, filed Jul. 30, 2014; the entire contents of which are incorporated herein by reference.

### FIELD

Embodiments described herein relate to a production control support apparatus and a production control support method.

### BACKGROUND

One of the conventional production control methods consists of setting an upper bound of semi-finished products (Work-In-Process) in a production line. The upper bound is called a WIP (Work-In-Process) upper bound. Two methods were employed to determine the WIP upper bound. One of the methods is to use a production line simulator and the other method is to use production results (actual values) of the on-site production line.

The downside of the method making use of the production line simulator is that calculations take a considerable amount of time. On the other hand, the method making use of actual values is the disadvantageous in that, in production lines having a relatively long lead time (time from feed-in to feed-out), production control implementation is delayed. The lead time is also called Turnaround Time (TAT).

### BRIEF DESCRIPTION OF THE DRAWINGS

FIG. 1 is a block diagram of a production control support apparatus according to an embodiment of the present invention;

FIG. 2 is a flowchart of an operation of the production control support apparatus in FIG. 1;

FIG. 3 is a schematic diagram of a model of a production line according to the embodiment of the present invention;

FIG. 4 is an explanatory graphic diagram of an operation of a blocking probability calculator;

FIG. 5 is a diagram illustrating a graph of a relationship between an upper bound value and a throughput;

FIG. 6 is a diagram illustrating a graph of a relationship between the upper bound value and turnaround time;

FIG. 7 is a block diagram of a modified example of the production control support apparatus in FIG. 1;

FIG. 8 is a block diagram of another modified example of the production control support apparatus in FIG. 1;

FIG. 9 is a block diagram of still another modified example of the production control support apparatus in FIG. 1; and

FIG. 10 is a block diagram of hardware of the production control support apparatus in FIG. 1.

### DETAILED DESCRIPTION

According to one embodiment of this invention, a production control support apparatus for a production line of a plurality of processes is provided. The processes are connected in tandem, each process including: a plurality of the machines for parallel processing and a buffer for one or more semi-finished products waiting to be processed by one of the machines.

The processing circuitry of the production control support apparatus calculates a relationship between an upper bound value of a number of semi-finished products which are allowed to exist within the production line and a blocking probability being a probability of the semi-finished product being kept in standby ahead of the production line due to the number of semi-finished products in the production line having reached the upper bound value.

The processing circuitry calculates a plurality of different functions depending on respective regions of the upper bound value based on: a number of machines existing in each process; a time interval for the semi-finished products to arrive at the production line; a statistical dispersion of the time interval; a time necessary for each machine in each process to process one semi-finished product; and a statistical dispersion of the necessary time, and thereby obtains a relationship between the upper bound value and the blocking probability for each of the regions. An association of the functions of the respective regions is a function where the blocking probability monotonically decreases depending on an increase of the upper bound value.

An embodiment of the present invention relates to a production control support apparatus and an automatic control method, which are applicable to a control system for setting to a number of semi-finished products (number of lots) an upper bound (hereinafter a work-in-process count) existing within a production line with a plurality of processes being connected in tandem which is typical of semiconductor manufacturing. The embodiment of the present invention will hereinafter be described with reference to the accompanying drawings.

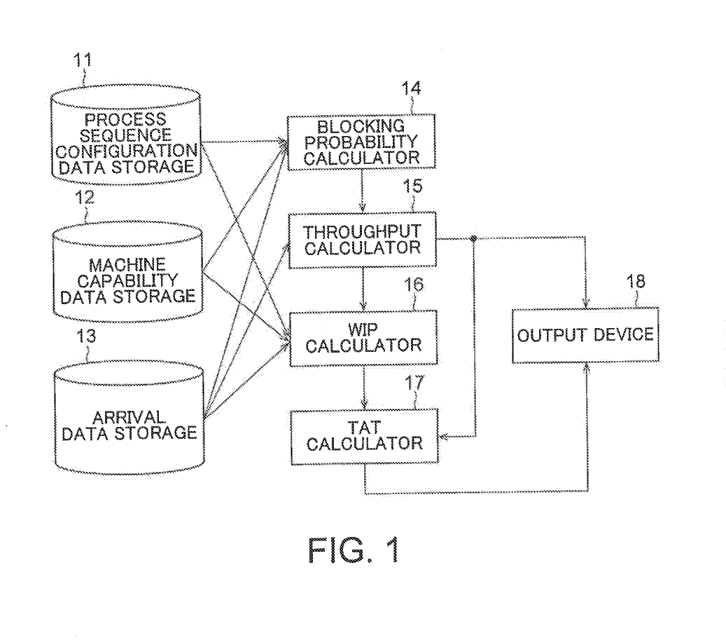

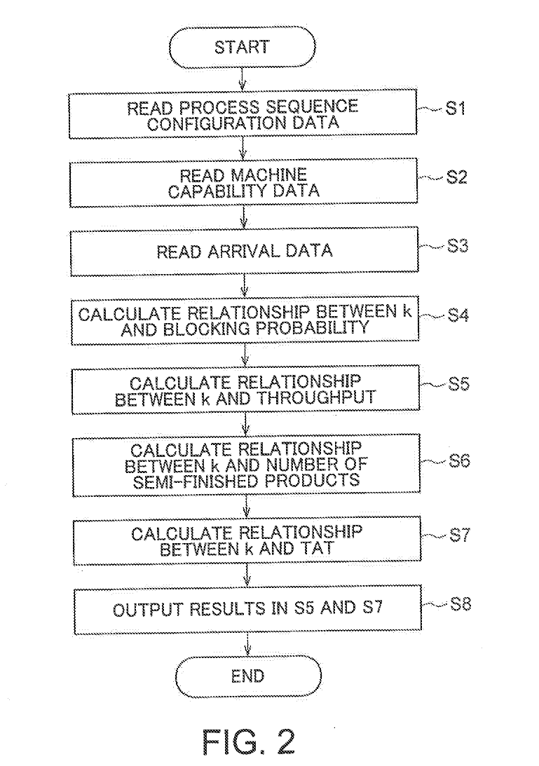

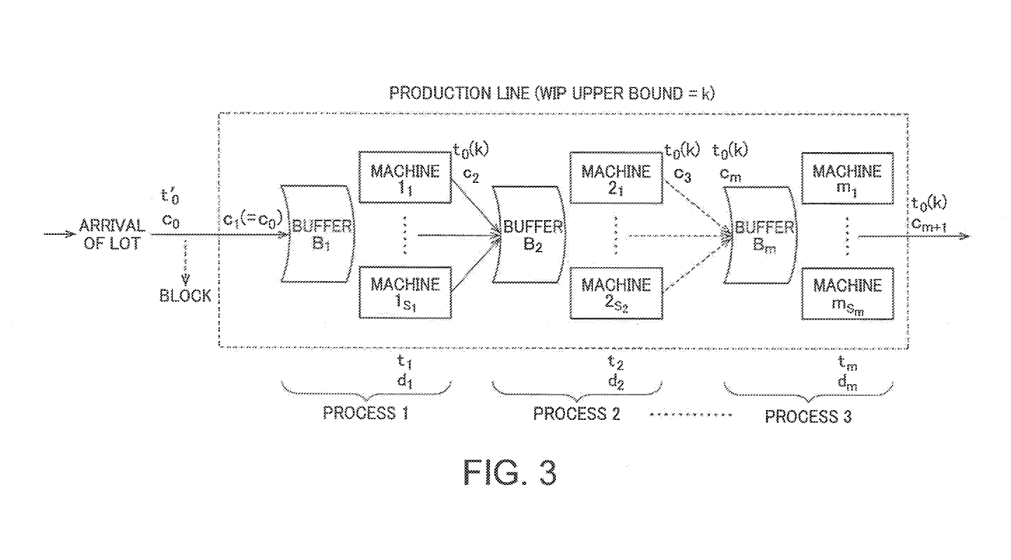

FIG. 1 is a block diagram of the production control support apparatus according to the embodiment of the present invention. FIG. 2 is a flowchart of an operation of the production control support apparatus in FIG. 1. FIG. 3 is a schematic diagram of a model of a production line according to the embodiment.

The production line being the subject of the embodiment is a production line which is configured to connect in tandem one or more processes, and is assumed to be a part of a semiconductor production process. The semi-finished products are deemed to be, but not limited to being, a lot. Note that the production line may be a whole process sequence ranging from feed-in to feed-out and may also be a partial process sequence taken from a whole process sequence.

FIG. 3 illustrates a process 1, a process 2, . . . , a process m being connected in tandem. One or more working machines (which will hereinafter be simply called machines) for processing the lot are prepared for every process. A shared buffer is disposed at a front stage of these machines. A capacity of the buffer is assumed to be infinite. The lot is temporarily stored in the buffer and is put in standby when the machines are unavailable. The lot is fed into and processed by any of the machines which are available or became available. After processing is complete, the lot is stored in the buffer of a next process or is fed out from the production line when the completed process is the last process. If the number of semi-finished products (the number of lots) within the production line amounts to an upper bound value (WIP upper bound=k), the lot arriving at the production line is kept in standby ahead of the production line. An assumption in the embodiment is that the number of lots kept in standby ahead of the production line is set to “1” at the maximum, and a new lot does not arrive while the lot is in standby. Parameters shown in FIG. 3 will be described later on. Note that an operation of processing and transferring the lot to the next process in each process via the buffer within the production line and an operation of keeping the lot arriving at the production line in standby ahead of the production line when the number of lots amounts to the upper bound value (WIP upper bound=k), are standard operations and hence will be no further explained. The production line may set the WIP upper bound and may control operations in each of its internal processes in accordance to the set WIP upper bound. This configuration is also standard in production lines.

As illustrated in FIG. 1, the production control support apparatus includes, a process sequence configuration data storage 11, a machine capability data storage 12, an arrival data storage 13, a blocking probability calculator 14, a throughput calculator 15, a WIP calculator 16, a TAT calculator 17 and an output device 18. All or part of the blocks in FIG. 1 may be configured by processing circuitry. The processing circuitry may be configured of one or more circuitry. As one example, the blocking probability calculator 14 may be configured by a first circuitry and the throughput calculator 15 may be configured by a second circuitry. The term “circuitry” may indicate one circuit, a plurality of circuits, or a system of circuits.

The process sequence configuration data storage 11 stores process sequence configuration data representing information about the process sequence. The process sequence configuration data contains a number of processes, a sequence of the processes, a number of machines in parallel for each process, and so on.

The machine capability data storage 12 stores machine capability data representing information of the capability of the machines. The machine capability data contains, e.g., average lot processing time of the machines in each process and a coefficient of variation thereof. The coefficient of variation is a value obtained by dividing a standard deviation by an average. The standard deviation being a positive square root of variance, the standard deviation or the variance may be used in place of the coefficient of variation. The coefficient of variation, the standard deviation and the variance are examples of indices representing statistical dispersion.

The arrival data storage 13 stores arrival data representing information about an arrival of lots. The arrival data contains, e.g., an average arrival interval of the lots at the production line and a coefficient of variation thereof. The standard deviation or the variance may also be used as a substitute for the coefficient of variation.

Herein, symbols used in the embodiment are defined (see FIG. 3).

m: a number of processes;
sₙ: a number of machines existing in an nth (n=1, . . . , m) process;
t′₀: an average time interval of the lots arriving at the production line;
c₀: a coefficient of variation of the time interval t′₀;
tₙ: average time needed for a single machine in the nth process to process one lot;
dₙ: a coefficient of variation of the average time tₙ;
t₀(k): an arrival interval of the lots arriving at each process (a value common among all processes; a steady state is assumed.) when the WIP upper bound is k;
cₙ: a coefficient of variation to the arrival interval of the lots arriving at the nth process; and
P_{B}(k): a probability of the lot been put in standby ahead of the production line (the probability being called a blocking probability) because the semi-finished products within the production line amount to the WIP upper bound (k). An Implication is that the standby time lengthens as this value increases. Note that the symbol “P_{B} (k)” is not displayed in FIG. 3.

The process sequence configuration data, the machine capability data and the arrival data contain “m” (the number of processes), “sₙ” (the number of machines existing in the nth (n=1, . . . , m) process, “t′₀” (the average time interval of the lots arriving at the production line), “c₀” (the coefficient of variation of t′₀), “tₙ” (the average time needed for the single machine in the nth process to process one lot), and “dₙ” (the coefficient of variation of tₙ). The parameters “t₀(k)”, “cₙ” and “P_{B}(k)” are calculated based on the operations of the embodiment, the operations being described below.

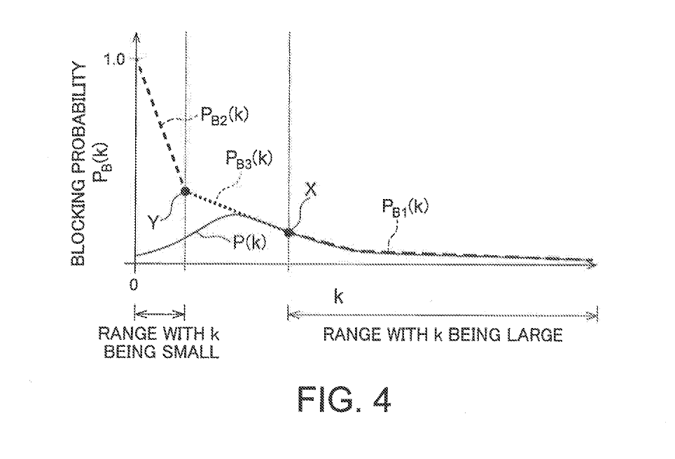

The blocking probability calculator 14 is connected to the process sequence configuration data storage 11, the machine capability data storage 12 and the arrival data storage 13. The blocking probability calculator 14 obtains, based on data of these storages, P_{B}(k) as a relationship between k and the blocking probability. The blocking probability calculator 14, with the WIP upper bound being set, calculates the coefficient of variation (the statistical dispersion) to the arrival interval of the lots arriving at each process. Different functions corresponding to each region of the WIP upper bound value are calculated by making use of the coefficient of variation, thereby calculating a relationship between the WIP upper bound and the blocking probability per region. In this situation, with respect to a function which associates the functions in the respective regions, the blocking probability monotonically decreases depending on a rise of the WIP upper limit. Further, a gradient of the blocking probability against the WIP upper bound may increase. Herein let the function P_{B} (k) be a function which calculates two functions, namely, a function P_{B1} (k) in a region where the upper bound k is large and a function P_{B2} (k) in a region where the upper bound k is small, and joins these two functions by another function P_{B3} (k). FIG. 4 is a diagram explaining the operations of the blocking probability calculator 14. Graphs of P_{B1} (k), P_{B2} (k) and P_{B3} (k) represented by broken lines are depicted in a coordinate system where k is the axis of abscissae and the blocking probability P_{B}(k) is the axis of ordinates. Further, a probability distribution P(k), to be described below, is also depicted therein.

It is assumed that the blocking probability P_{B1} (k) in the region with the large upper bound k is coincident with a state probability distribution (denoted by P(w)) to which the number of semi-finished products within the production line corresponds when k=∞. The state probability distribution P(w) reflects a probability that the number of semi-finished products within the production line is w. In other words, it is considered that P_{B} (k)=P(k) in the region with the large upper bound k.

The state probability distribution P(k) represents a probability that the number of semi-finished products within the production line is k. When assuming that the upper bound k is ∞ (the upper bound value within the production line is ∞), a value of P(k) (a probability that the number of semi-finished products within the production line is ∞) is infinitesimally small. The value of P(k) increases as the k value decreases, and a gradient (differential value) thereof begins to widely vary. In such situation, e.g., for a specific point where the gradient (differential value) of P(k) is minimal (for negative values, its absolute value is maximal), a region equal to or larger than k's value corresponding to this specific point is considered as a region of a large k. It is considered that in this region P_{B} (k)=P(k). This is because, upon decreasing k from ∞, a vicinity in which P_{B} (k) starts rising corresponds to a position at which P(k) starts rising. Thus, the probability distribution P(k) is used as the blocking probability P_{B} (k) in the region of a large k. In FIG. 4, P_{B1} (k) corresponds to the blocking probability P_{B} (k) in the region of a large k.

Herein, the probability distribution P(w) is calculated by calculating probability distributions Pₙ(w) of the respective processes and adding up the distributions thus calculated across all of the processes. The probability distribution Pₙ(w) is calculated using the following formula. In the formula, u represents a usage rate of the machine and is given by u=tₙ/(t′₀×sₙ). In concrete terms, the following formula, an extension of a known formula, includes, a term of cₙ added to the known formula (refer to a calculation expression of formula (4)).

when w<sₙ:

$$\begin{matrix}{P}_{n} ( w ) = \frac{{( {s}_{n} u )}^{w}}{w !} P ( 0 ) & Formula ( 1 ) \\ however , & \\ P ( 0 ) = \frac{1}{{\sum }_{i = 0}^{s - 1} \frac{{( {s}_{n} u )}^{i}}{i !} + \frac{{( {s}_{n} u )}^{s}}{s ! ( 1 - u )}} & Formula ( 2 )\end{matrix}$$

when w≧sₙ:

$$\begin{matrix}{P}_{n} ( w ) = {b}^{w - s} ( 1 - b ) \prod & Formula ( 3 ) \\ however , & \\ b = \frac{( {c}_{n}^{2} + {d}_{n}^{2} ) u}{2 - ( 2 - {c}_{n}^{2} - {d}_{n}^{2} ) u} , \\ \prod = \frac{\frac{{( {s}_{n} u )}^{s}}{s ! ( 1 - u )}}{{\sum }_{i = 0}^{s - 1} \frac{{( {s}_{n} u )}^{i}}{i !} + \frac{{( {s}_{n} u )}^{s}}{s ! ( 1 - u )}} & Formula ( 4 )\end{matrix}$$

Here, cₙ (n=2, . . . , m) is calculated by using the following recurrence formula:

$$\begin{matrix}{c}_{n + 1}^{2} = 1 + ( 1 - {u}^{2} ) ( {c}_{n}^{2} - 1 ) + \frac{{u}^{2}}{\sqrt{{s}_{n}}} ( {d}_{n}^{2} - 1 ) & Formula ( 5 ) \\ however , & \\ {c}_{1} = {c}_{0} & Formula ( 6 )\end{matrix}$$

As mentioned above, cₙ is a coefficient of variation (statistical dispersion) to the arrival interval of the lot arriving at the nth process.

An operation of adding up the probability distributions Pₙ(w) of the respective processes across all of the processes, is executed by applying a Monte Carlo method on a calculator. As one example, the probability distribution of P(w) is acquired by repeating a procedure of counting an occurrence of a sum w obtained from the respective processes by making use of such a random number generator as to obtain w in accordance with the probability of Pₙ(w).

On the other hand, it is assumed that the blocking probability P_{B} (k) in the region where k is small (namely, P_{B2} (k)) conforms to the following formula:

$${P}_{B} ( k ) = 1 - \frac{{t}_{0}^{′}}{{\sum }_{i = 1}^{m} {t}_{1}} k \qquad Formula ( 7 )$$

An elicitation process of this formula is hereinafter described.

An implication of k being small is that a small number of lots exist within the production line, resulting in a low probability of the lot being kept waiting ahead of the machine. In other words, a period of time (TAT) from the time the lot is fed into the production line until is fed out from the production line can be approximated by TAT=t₁+ . . . +tₘ (t₁, . . . , tₘ: the lot processing time by the machines in each process). The accuracy of this approximation increases with smaller values of k and thus, with a larger number of machines. Furthermore, when k is small and “t₁+ . . . +tₘ” is significantly larger than t′₀, the situation of lots in standby ahead of the production line is likely to occur when lots exit the production line. In other words, as one lot exits the production line, the lot in standby promptly enters the production line. Namely, the number of lots (WIP) within the production line can be approximated to WIP=k. On the other hand, the throughput is obtained by using the blocking probability P_{B} (k): Throughput=(1−P_{B}(k))/t′₀,

where t′₀ is the arrival interval of the lot arriving at the production line. A relationship “TAT=WIP Count÷Throughput” being known from Little's formula, an equation “t1+ . . . +tm=k×(t′₀/(1−P_{B}(k)))” is obtained. Transforming this formula, a formula of the blocking probability used when k is small,

P_{B}(k)=1−k(t′₀/(t₁+ . . . +tₘ))

is eventually obtained.

The function in which P_{B}(k) decreases monotonically (namely, P_{B3} (k)) is a connection between the blocking probability P_{B}(k) in the region of the large k (namely, P_{B1}(k)) and the blocking probability P_{B}(k) in the region of the small k (namely, P_{B2}(k)). In this situation, assuming that the blocking probability P_{B}(k) is always equal to or larger than the probability distribution P(k), a condition may be that P_{B3} (k) does not drop below the probability distribution P(k). Such a function is the blocking probability P_{B}(k) (namely, P_{B3}(k)) in a region between the region of small k and the region of large k.

Concretely, let a minimum gradient α in the probability distribution P(k) as described above be set as α (<0). In other words, the minimum value of differential values of the probability distribution is calculated and it is set as α. A point on the probability distribution P(k) to be this gradient is designated as X. Here, as in FIG. 4, a straight line of the gradient α, which passes through the point X, is defined. Here, the region of small k is a region where k is equal to or smaller than a value corresponding to an intersection Y between the abovementioned straight line and a graph of “the blocking probability P_{B}(k) in the region of small k (see Formula (7))”. Further, the region of large k is a region where k is equal to or larger than a value corresponding to the point X. The function P_{B3}(k) is a function of the abovementioned straight line in a region with k being larger than the value corresponding to the intersection Y but smaller than the value corresponding to the intersection X. The values of this function are equal to or larger than the probability distribution P(k).

Herein, in the probability distribution, the point of the minimum gradient α is used. However, this is one example, and P_{B}(k)=P(w) may be used in a region where k is equal to or larger than w, with P(w) being the maximum value. Further, as long as P_{B}(k) decreases monotonically, P_{B1}(k) and P_{B2}(k) may be joined in whatever manner, the connection may be a straight line or a curve. A condition of “P_{B} (k)≧P(k)” may also be added.

Through the procedure described above, the blocking probability P_{B}(k) when the WIP upper bound of the production line is considered to be k is obtained.

The throughput calculator 15 in FIG. 1 is connected to the arrival data storage 13. The throughput calculator 15 calculates a relationship φ(k) between k and the throughput by making use of the data of the arrival data storage 13 and the blocking probability P_{B}(k) (obtained by associating P_{B2}(k), P_{B3}(k) and P_{B1}(k)) calculated by the blocking probability calculator 14.

The blocking probability being a probability that the lot is kept waiting ahead of the production line in order for the semi-finished products within the production line to reach the WIP upper bound k (the larger its value, the longer the standby time), the interval of the lots entering the production line widens as the blocking probability increases. Supposing that the lot arrives at an interval of, e.g., 100 minutes and the blocking probability is 50%, a lot enters the production line every 150 minutes. The throughput is a count of lot deliveries per unit time. When the production line is in the steady state, the number of lots per unit time which are fed into the production line equals the throughput. Hence, Φ(k) is obtained from the following formula:

$$φ ( k ) = \frac{1 - {P}_{B} ( k )}{{t}_{0}^{′}} \qquad Formula ( 8 )$$

The WIP calculator 16 is connected to the process sequence configuration data storage 11, the machine capability data storage 12 and the arrival data storage 13. The WIP calculator 16 calculates a relationship W(k) between k and the number of semi-finished products within the production line, the calculation being based on the data in these storages and on the relationship between the WIP upper bound k and the throughput as calculated by the calculator 15.

The relationship W(k) is obtained by calculating a semi-finished product count Wₙ(k) (n=1, 2, . . . , m) in the respective processes and the addition of these product counts.

The semi-finished product count Wₙ(k) in each process may be calculated, e.g., using the following formula:

$${W}_{n} ( k ) = \frac{{c}_{n}^{2} + {d}_{n}^{2}}{2} \frac{u \sqrt{2 ( s + 1 ) - 1}}{1 - u} + su \qquad Formula ( 9 )$$

This is a known formula. However, herein u=tₙ/(t₀×sₙ) (note that t′₀ is replaced by t₀ in the defining expression of u as stated above).

Alternatively, the calculation of Wₙ(k) may make use of the calculation formula introduced in an article titled “Interpolation Approximations for The Mean Waiting Time in A Multi-Server Queue”, authored by Toshikazu Kimura, Journal of the Operations Research Society of Japan, Vol. 35, pp. 77-92, 1992. The present embodiment uses the calculation formula in this article to calculate Wₙ(k). The formula in the article makes use of the arrival interval (t₀(k) as previously defined) of the lots arriving at each process. This value is given by an inverse number of the throughput φ(k) calculated by the throughput calculator 15:

$${t}_{0} ( k ) = \frac{1}{φ ( k )}$$

This value is shared among the respective processes.

W(k) is calculated by the following formula.

W(k)=Σₙ₌₁^{m}Wₙ(k) Formula (10)

The TAT calculator 17 calculates a relationship T(k) between k and TAT by using the relationship φ(k) calculated by the throughput calculator 15 and the relationship W(k) calculated by the WIP calculator 16.

The relationship T(k) may be calculated by making use of the publicly known formula called the Little's formula. To be specific, the relationship between k and TAT is obtained from the following formula:

$$T ( k ) = \frac{w ( k )}{φ ( k )} \qquad Formula ( 11 )$$

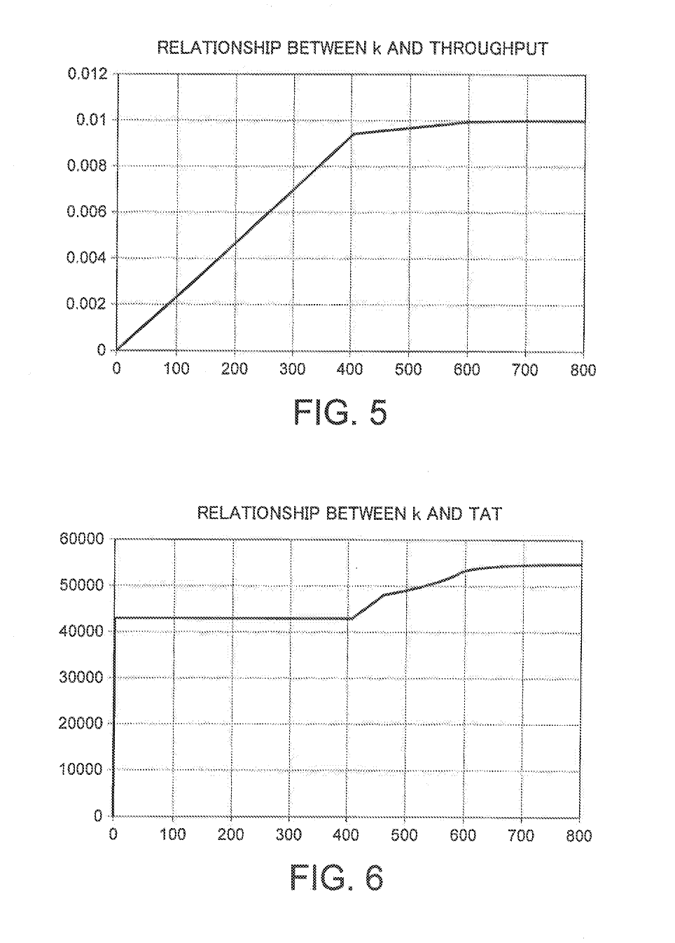

The output device 18 outputs data representing the relationship φ(k) calculated by the throughput calculator 15 and the relationship T(k) calculated by the TAT calculator 17.
An output format may be selected from various formats such as graphs, tables and functions format. The output device 18 may be a display device to display the data as an image or a communication device to transmit the data to the outside. FIGS. 5 and 6 illustrate examples of results of outputting the relationship between k and the throughput and the relationship between k and TAT in graph format.

FIG. 2 is a flowchart illustrating an operation of the production control support machine in FIG. 1.

The production control support machine reads the process sequence configuration data from the process sequence configuration data storage 11, reads the machine capability data from the machine capability data storage 12, and reads the arrival data from the arrival data storage 13 (S1, S2, S3).

Based on the data read from the respective storages, the blocking probability calculator 14 calculates the coefficient of variation (statistical dispersion) to the arrival interval of the lot arriving at each process, and calculates the relationship between the WIP upper bound and the blocking probability (S4). For example, the blocking probability calculator 14 calculates the relationship between the WIP upper bound and the blocking probability by using the formulas 1-7 given above.

More specifically, for a probability distribution to which the number of semi-finished products existing within the production line conforms when the WIP upper bound is infinite, the blocking probability calculator 14 uses a probability distribution of a first value which is a value larger than or equal to a value corresponding to a point of maximum value of the probability distribution (maximum probability) as the relationship between the WIP upper bound and the blocking probability in a region where the WIP upper bound is equal or larger than the first value. As one example, the first value may be the WIP upper bound value corresponding to the point for which the differential value of the probability distribution is minimal.

Further, the blocking probability calculator 14 employs the formula (7) as the relationship between the WIP upper bound and the blocking probability in a region where the WIP upper bound value is equal or larger than 0 and equal or less than a second value (which is smaller than the first value).

Moreover, in a region of values larger than the second value but smaller than the first value, a function for which the value of the blocking probability monotonically decreases corresponding to the increase of the WIP upper bound is employed as the relationship between the WIP upper bound and the blocking probability. A condition may be added that a value of this function is equal to or larger than the probability distribution.

Based on the relationship between the WIP upper bound calculated by the blocking probability calculator 14 and the blocking probability, and the time interval (contained in the arrival data) of the semi-finished product arriving at the production line, the throughput calculator 15 calculates the relationship between the WIP upper bound and the throughput(S5). For instance, the relationship between the WIP upper bound and the throughput is calculated in accordance with the formula (8) given above.

The WIP calculator 16 calculates the relationship between the WIP upper bound and the number of semi-finished products within the production line (S6). For example, the relationship therebetween is calculated by the method described in the foregoing article of “Toshikazu Kimura” on the basis of the inverse number of the throughput. Alternatively, this relationship may also be calculated according to the formula 9. Based on the relationships between the WIP upper bound and the throughput on one hand, and the relationship between the WIP upper bound and the number of semi-finished products within the production line on the other hand, the TAT calculator 17 calculates a relationship between the WIP upper bound and turnaround time (S7). For example, this relationship is calculated according to the formula 11 given above.

The output device 18 outputs data representing the relationships calculated in steps S5 and S7, i.e., data representing the relationship between the WIP upper bound and the throughput and data representing the relationship between the WIP upper bound and the turnaround time (S8). A data output format may be selected from various formats such as graphs, tables or functions.

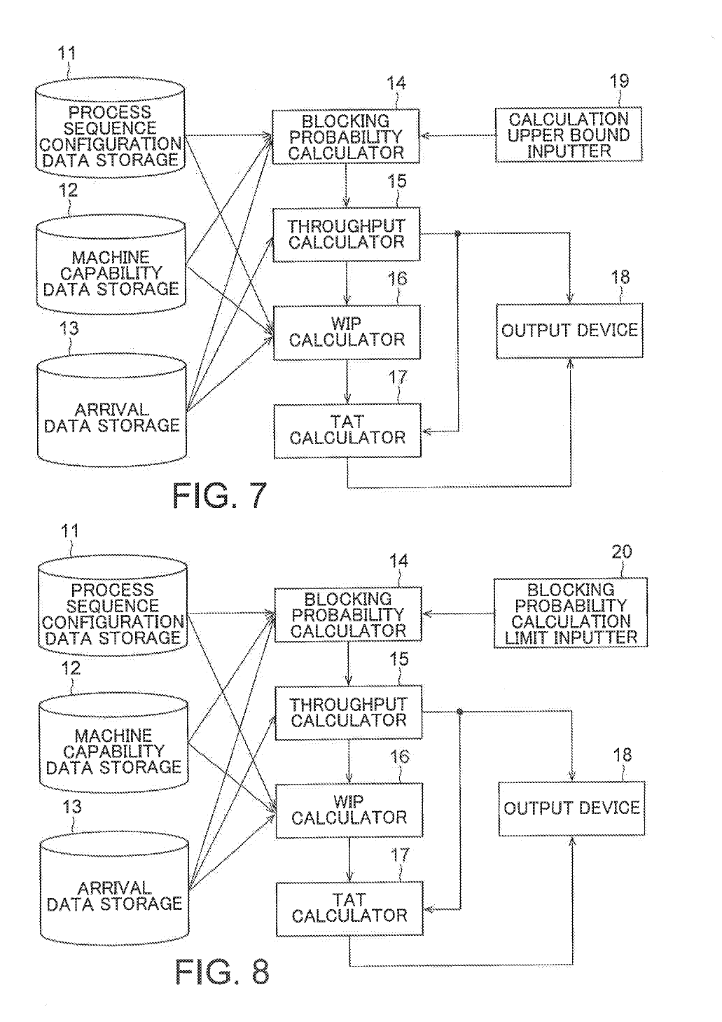

Herein, a user may be allowed to specify the upper bound value k when the blocking probability calculator 14, the throughput calculator 15, the WIP calculator 16 and the TAT calculator 17 perform calculations according to the formulas given above. For example, as illustrated in FIG. 7, a calculation upper bound inputter 19 is added to the production control support machine in FIG. 1. The user may input the upper bound value k by means of the calculation upper bound inputter 19. The blocking probability calculator 14 reads the upper bound value k from the calculation upper bound inputter 19, and performs the calculation up to the upper bound value k. A lower bound value k is preset to, e.g., “0”. Other processing units also perform calculations up to the upper bound value k.

From the fact that the blocking probability nears “0” as the value k increases, the user may be allowed to specify a blocking probability calculation limit value which indicates an extent to which the blocking probability should near “0” for the calculation to stop. For instance, as depicted in FIG. 8, a blocking probability calculation limit inputter 20 is added to the production control support machine in FIG. 1. The user inputs a blocking probability calculation limit value using the blocking probability calculation limit inputter 20. The blocking probability calculator 14 reads the blocking probability calculation limit value from the blocking probability calculation limit inputter 20, and performs the calculation up to a k so that the blocking probability becomes equal to or smaller than the blocking probability calculation limit value. For example, the blocking probability calculation limit value being set to 10⁻⁸, the calculation continues to be performed up to a k for which the blocking probability becomes equal to or smaller than 10⁻⁸. Note that the results in FIGS. 5 and 6 correspond to an example of setting the blocking probability calculation limit value to 10⁻⁸.

The data used for obtaining the results in FIGS. 5 and 6 targets a production line of 20 processes, with a maximum of about 100 machines per process. A calculation time is approximately 5 seconds for outputting the results in FIGS. 5 and 6 which may be considered to be extremely short. Further, compared to results calculated using conventional simulators, the margin of error thereof is within 5%.

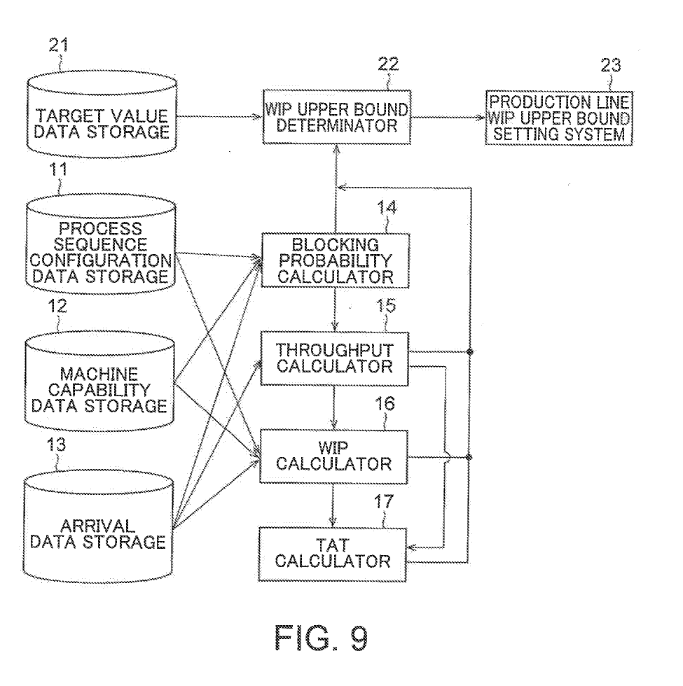

FIG. 9 illustrates an example of a configuration in which a target value data storage 21 and a WIP upper bound determinator 22 are added to the production control support machine in FIG. 1, such added components being connected to a WIP upper bound setting system 23 of the production line. The use of the production control support machine according to the present embodiment enables a production control system which automatically modifies the WIP upper bound k according to an index target value for the production line, as specified by the user.

The target value data storage 21 stores data of values pertaining to any one of a target blocking probability, a target throughput, a target number of semi-finished products and target TAT.

Regarding the target blocking probability, the WIP upper bound determinator 22 refers to the calculation result (the relationship between k and the blocking probability) of the blocking probability calculator 14 to determine the k matching the target blocking probability. The WIP upper bound setting system 23 sets this k as the WIP upper bound for the production line.

Regarding the target throughput, the WIP upper bound determinator 22 refers to the result (the relationship between k and the throughput) of the throughput calculator 15 to determine the k matching the specified throughput. The WIP upper bound setting system 23 sets this k as the WIP upper bound for the production line.

Regarding the target number of semi-finished products, the WIP upper bound determinator 22 refers to the result (the relationship between k and the number of semi-finished products) of the WIP calculator 16 to determine the k matching the specified number of semi-finished products. The WIP upper bound setting system 23 sets this k as the WIP upper bound for the production line.

Regarding the target TAT, the WIP upper bound determinator 22 refers to the result (the relationship between k and TAT) of the TAT calculator 17 to determine the k matching the specified TAT. The WIP upper bound setting system 23 sets this k as the WIP upper bound for the production line.

By means of the above, the WIP upper bound may be automatically determined to meet the target value and set into the production line.

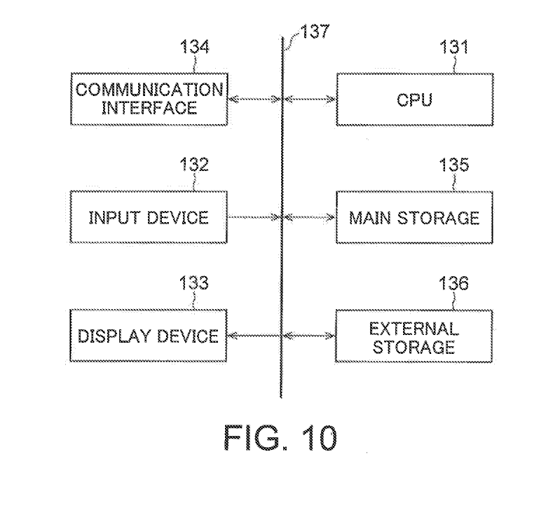

FIG. 10 is a hardware block diagram of the production control support machine according to the embodiment of the present invention. The production control support machine features a computer and is capable of performing wireless or wired communication. The production control support machine, with the computer executing the program as one example, accomplishes the functions of the respective blocks in FIGS. 1, 7, 8 and 9.

The production control support machine features a CPU 131, an input device 132, a display device 133, a communication interface 134, a main storage 135 and an external storage 136, these components being interconnected via a bus 137.

The CPU (Central Processing Unit) 131 is a processor which executes a control program on the main storage 135. The control program is a program to accomplish respective functional configurations. The CPU 131 executes the control program, thereby accomplishing the respective functions described above.

The input device 132 is a device for inputting data and instructions to a control device 101 from outside. The input device 132 may be a device for the user to directly input, such as a keyboard, a mouse or a touch panel. Further, the input device 132 may be a device such as a USB, or software enabling an input from the external device.

When the control program is executed, the main storage 135 stores the control program, data (may include state information) necessary for executing the control program and data generated by executing the program. The control program is loaded into the main storage 135 and then executed. The main storage 135 may be, without being limited to, a RAM, a DRAM or a SRAM, for example.

The external storage 136 stores the control program, data (may include state information) necessary for executing the control program and data generated by executing the program. The program and the data are read to the main storage 135 when executing the control program. The external storage 136 may be, without being limited to, a hard disk, an SSD, an optical disc or a flash memory, for example. The respective storages in FIGS. 1, 7, 8 and 9 may be built up on at least one of the main storage 135 and the external storage 136.

The display device 133 is a display which displays video signals output from the CPU (Central Processing Unit) 131. The display device 133 may be, without being limited to, a LCD (liquid crystal display), a CRT (cathode ray tube) or a PDP (plasma display panel), for example. Information held in the storages in FIGS. 1, 7, 8 and 9 may be displayed on the display device 133.

The communication interface 134 is a device to communicate with the outside. The production control support machine may be configured to perform wireless or wired communication with external devices via the communication interface 134 by a predetermined communication method.

Note that the control program may be preinstalled into the computer and may also be stored on a storage medium such as a CD-ROM. Further, the control program may also be uploaded to the Internet. The production control support machine may also be configured not to include at least one of the input device 102, the display device 103 and the communication interface 134.

As discussed above, according to the embodiment of the present invention, the queuing theory applied calculation enables fast acquisition of information for properly determining the upper bound of the number of semi-finished products within the production line. For instance, it is possible to calculate at high speed the relationship between the WIP upper bound and the blocking probability, the relationship between the WIP upper bound and the number of semi-finished products within the production line, the relationship between the WIP upper bound and the throughput, and the relationship between the WIP upper bound and TAT. The conventional methods using production simulators and the values of the actual results required a considerable length of time for the calculations, but no such problem arises in the present embodiment.

Moreover, the proper WIP upper bound may be determined by using the relationship between the WIP upper bound and the throughput, and the relationship between the WIP upper bound and TAT. Alternatively, the WIP upper bound may be determined by using one of these four relationships and the target value (the target blocking probability, the target throughput, the target number of semi-finished products or target TAT). The WIP upper bound thus determined may be used to control the production line. Conventional systems using actual values are slow to implement control alterations in production lines which lead time (also called TAT) is long. However, no such problem occurs in the present embodiment.

The terms used in each embodiment should be broadly interpreted. For example, the term “processor” may encompass a general-purpose processor, a central processing unit (CPU), a microprocessor, a digital signal processor (DSP), a controller, a microcontroller, a state machine, etc. According to circumstances, a “processor” may refer to an application specific integrated circuit (ASIC), a field programmable gate array (FPGA), or a programmable logic device (PLD), etc. The term “processor” may refer to a combination of processing devices such as a plurality of microprocessors, a combination of a DSP and a microprocessor, one or more microprocessors in conjunction with a DSP core.

As another example, the term “memory” may encompass any electronic component which can store electronic information. The “memory” may refer to various types of media such as random access memory (RAM), read-only memory (ROM), programmable read-only memory (PROM), erasable programmable read only memory (EPROM), electrically erasable PROM (EEPROM), non-volatile random access memory (NVRAM), flash memory, magnetic or optical data storage, which are readable by a processor. It can be said that the memory electrically communicates with a processor if the processor reads and/or writes information for the memory. The memory may be integrated to the processor, in which case, it can be said that the memory electrically communicates with the processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A production control support apparatus for a production line of a plurality of processes being connected in tandem, one process including: a plurality of machines for parallel processing and a buffer for one or more semi-finished products waiting to be processed by one of the machines; comprising:
processing circuitry configured to calculate a relationship between an upper bound value of a number of semi-finished products which are allowed to exist within the production line and a blocking probability being a probability of the semi-finished product being kept in standby ahead of the production line due to the number of semi-finished products within the production line reaching the upper bound value,
wherein the processing circuitry calculates a plurality of different functions depending on respective regions of the upper bound value based on: a number of machines existing in each process; a time interval of the semi-finished products arriving at the production line; a statistical dispersion of the time interval; a time necessary for one machine in each process to process one semi-finished product; and a statistical dispersion of the necessary time; and thereby obtains a relationship between the upper bound value and the blocking probability for each of the regions, and
an association of the functions of the respective regions is a function where the blocking probability monotonically decreases depending on an increase of the upper bound value.

2. The production control support apparatus according to claim 1, wherein the processing circuitry employs, in a probability distribution to which the number of semi-finished products existing within the production line conforms when a value of the upper bound is infinite, a segment of the probability distribution that is equal to or larger than a first value of the number of semi-finished products, the first value being equal to or larger than a value corresponding to a point of maximum probability of the probability distribution, as a relationship between the upper bound value and the blocking probability in a region where the upper bound value is equal to or larger than the first value.

3. The production control support apparatus according to claim 2, wherein the processing circuitry employs the following formula as a relationship between the upper bound value and the blocking probability in a region where the upper bound value is equal to or larger than 0 and equal to or smaller than a second value, the second value being smaller than the first value:
$${P}_{B} ( k ) = 1 - \frac{{t}_{0}^{′}}{{\sum }_{i = 1}^{m} {t}_{i}} k$$
where t′₀ represents a time interval of the semi-finished products arriving at the production line, tₙ denotes a time necessary for one machine in an nth process to process one semi-finished product, k is the upper bound value, and P_{B}(k) indicates the blocking probability.

4. The production control support apparatus according to claim 1, wherein the processing circuitry employs, in a probability distribution to which the number of semi-finished products existing within the production line conforms when a value of the upper bound is infinite, a segment of the probability distribution that is equal to or larger than a first value of the number of semi-finished products in the probability distribution, the first value being equal to or larger than an upper bound value corresponding to a point of maximum probability of the probability distribution, as a relationship between the upper bound value and the blocking probability in a case that the upper bound value is equal to or larger than the first value, wherein
the processing circuitry employs the following formula as a relationship between the upper bound value and the blocking probability in a region where the upper bound value is equal to or larger than 0 and equal to or smaller than a second value smaller than the first value:
$${P}_{B} ( k ) = 1 - \frac{{t}_{0}^{′}}{{\sum }_{i = 1}^{m} {t}_{i}} k$$
where t′₀ represents a time interval of the semi-finished products arriving at the production line, tₙ denotes time necessary for one machine in an nth process to process one semi-finished product, k is the upper bound value, and P_{B}(k) indicates the blocking probability, and
in a region where the upper bound value is larger than the second value and smaller than the first value, a function where the blocking probability monotonically decreases depending on an increase of the upper bound value is used as the relationship between the upper bound value and the blocking probability.

5. The production control support apparatus according to claim 2, wherein the first value is the upper bound value corresponding to a point of the probability distribution for which the differential value is minimal.

6. The production control support apparatus according to claim 1, wherein the statistical dispersion is a coefficient of variation, a standard deviation or a variance.

7. The production control support apparatus according to claim 1, wherein the processing circuitry calculates a relationship between the upper bound value and a throughput being the number of semi-finished products per unit of time being fed out from the production line, on basis of the relationship between the upper bound value and the blocking probability and of the time interval of the semi-finished product arriving at the production line.

8. The production control support apparatus according to claim 7, wherein the processing circuitry calculates a relationship between the upper bound value and the number of semi-finished products existing within the production line on basis of an inverse number of the throughput.

9. The production control support apparatus according to claim 8, wherein the processing circuitry calculates a relationship between the upper bound value and turnaround time being a period of time from the time the semi-finished product is fed into the production line until it is fed out from the production line, on basis of the relationship between the upper bound value and the throughput and of the relationship between the upper bound value and the number of semi-finished products existing within the production line.

10. The production control support apparatus according to claim 9, wherein the processing circuitry outputs a first data and a second data where the first data represents the relationship between the upper bound value and the throughput, and the second data represents the relationship between the upper bound value and the turnaround time.

11. The production control support apparatus according to claim 10, wherein the first data and the second data are output in a format of a graph, a table or a function.

12. The production control support apparatus according to claim 1, wherein
the processing circuitry inputs a maximum value of the upper bound value,
the processing circuitry calculates the relationship between the upper bound value and the blocking probability only in a region from a predetermined lower limit value up to the said maximum value.

13. The production control support apparatus according to of claim 1, wherein the processing circuitry inputs a threshold value of the blocking probability,
the processing circuitry calculates the relationship between the upper bound value and the blocking probability while sequentially increasing the upper bound value and stops calculating the relationship when the blocking probability becomes less than or equal to the said threshold value.

14. The production control support apparatus according to claim 9, wherein the processing circuitry specifies the upper bound value from the relationship between the upper bound value and the blocking probability on the basis of a target blocking probability, or specifies the upper bound value from the relationship between the upper bound value and the throughput on the basis of a target throughput, or specifies the upper bound value from the relationship between the upper bound value and the number of semi-finished products existing within the production line on basis of a target number of semi-finished products existing within the production line, or specifies the upper bound value from the relationship between the upper bound value and the turnaround time on the basis of a target turnaround time,
the upper bound value determined by the circuitry is notified to a setting system which sets the upper bound value in the production line and controls production.

15. A production control support method for a production line of a plurality of processes being connected in tandem, each process including: a buffer for one or more semi-finished products waiting to be processed; a plurality of machines in parallel to process the semi-finished products waiting in the buffer; comprising:
calculating a relationship between an upper bound value of a number of semi-finished products which are allowed to exist within the production line and a blocking probability being a probability of the semi-finished product being kept in standby ahead of the production line due to the number of semi-finished products within the production line reaching the upper bound value, and
calculating a plurality of different functions depending on regions of the upper bound value based on: a number of machines existing in each process; a time interval of the semi-finished products arriving at the production line; a statistical dispersion of the time interval; a time necessary for one machine in each process to process one semi-finished product; and a statistical dispersion of the necessary time; and thereby obtaining a relationship between the upper bound value and the blocking probability for each of the regions, and
wherein an association of the functions of the respective regions is a function where the blocking probability monotonically decreases depending on an increase of the upper bound value.
